(19) United States
(12) Patent Application Publication
(10) Pub. No.: US 2020/0084177 A1
(43) Pub. Date: Mar. 12, 2020

(54) DNS NETWORK SYSTEM, DOMAIN-NAME PARSING METHOD AND SYSTEM

(71) Applicant: WANGSU SCIENCE & TECHNOLOGY CO., LTD., Shanghai (CN)

(72) Inventors: Xiaoying WU, Shanghai (CN); Jianxiong WANG, Shanghai (CN); Weiji ZHENG, Shanghai (CN); Zhenyong WU, Shanghai (CN)

(21) Appl. No.: 15/743,472

(22) PCT Filed: Nov. 16, 2016
(86) PCT No.: PCT/CN2016/106049

§ 371 Date: Jan. 10, 2018

(30) Foreign Application Priority Data
Jul. 14, 2016 (CN) 201610552767.4

(51) Int. Cl. H04L 29/12; H04L 29/08

(52) U.S. Cl. CPC H04L 61/1511; H04L 61/1552; H04L 67/1021; H04L 67/2842; H04L 61/6009

(57) ABSTRACT

The present disclosure provides a DNS network system, and a domain-name parsing method and system. A local DNS server receives a domain-name parsing request from a client terminal a network operator in the same network and sends the domain-name parsing request to a root server; based on an NS record of an upper-level authoritative DNS server returned by the root server, sends the domain-name parsing request to the upper-level authoritative DNS server; based on an NS record of an external authorized server returned by the upper-level authoritative DNS server, sends the domain-name parsing request to the external authorized server; based on an A-record of a lower-level authoritative DNS server returned by the external authorized server, sends the domain-name parsing request to the lower-level authoritative DNS server and receives a domain-name parsing result sent by the lower-level authoritative DNS server.

### FIELD OF THE DISCLOSURE

The present disclosure relates to the field of network communication, and more particularly, relates to a domain name system (DNS) network system, a domain-name parsing method and system, a database system, and a server.

### BACKGROUND

Existing DNS server networks generally use global configuration. The DNS servers of each public network often randomly select an authoritative DNS server when sending a parsing request. Thus, the DNS servers are, to a large extent, not able to select the optimized authoritative DNS server for the parsing request, directly causing a longer request time. For example, if ten (10) authoritative DNS servers are shared by the users all over the world, the public recursive DNS servers of each country randomly select one of the authoritative DNS servers to access. There is a high probability the public recursive DNS servers are not able to select the optimized authoritative DNS server.

In addition, many domain name registrars do not distinguish domain names, and they are not able to directly zone and authorize the upper authoritative DNS server of the domain name registrars. Thus, the existing DNS network architecture needs to be further optimized in terms of parsing method, to improve the efficiency of parsing.

### BRIEF SUMMARY OF THE DISCLOSURE

In view of the shortcomings of the conventional technology, the goal of the present disclosure includes providing a DNS network system, a domain-name parsing method and system, a database system, and a server, to solve the problem such as low domain-name parsing efficiency, caused by inferior zonings in parsing servers in the conventional technology.

To implement the aforementioned goal and other related goals, the present disclosure provides a DNS network system, including: a local DNS server of at least one network operator, for receiving a domain-name parsing request from a client terminal of the at least one network operator, and sending the domain-name parsing request from a root server to a lower-level authoritative DNS server level by level for a recursive query; an upper-level authoritative DNS server, for storing an NS record of at least one external authorized server to, when receiving the domain-name parsing request from the local DNS server, provide a corresponding NS record to the local DNS server based on information of a top-level domain name in the domain-name parsing request, such that the local DNS server can access the external authorized server; the external authorized server, storing at least one IP address and geographical location information of the at least one network operator having a one-to-one correspondence relationship with the at least one IP address, wherein the geographical location information of the at least one network operator each associates with an A-record of a corresponding lower-level authoritative DNS server, the external authorized server being configured to, when receiving the domain-name parsing request from the local DNS server, match a public IP of the local DNS server with the at least one IP address to locate the geographical location information of the network operator, and provide the A-record of the corresponding lower-level authoritative DNS server associated with the network operator to the local DNS server for the local DNS server to access; and the lower-level authoritative DNS server, for parsing the domain-name parsing request, when receiving the domain-name parsing request sent by the local DNS server, to provide a domain-name parsing result to the local DNS server.

In one embodiment, providing a corresponding NS record to the local DNS server based on information of a top-level domain name in the domain-name parsing request, such that the local DNS server can access the external authorized server includes: providing, by the upper-level authoritative DNS server, the external authorized server to the local DNS server, a top-level domain name parsed by the external authorized server being different from the top-level domain name in the domain-name parsing request.

In one embodiment, when adding or deleting an external authorized server and/or a lower-level authoritative DNS server, the NS record and/or corresponding A-record are modified accordingly.

To implement the aforementioned goal and other related goals, the present disclosure provides a server, storing of a NS record of at least one external device, configured to provide a corresponding NS record based on information of a top-level domain name in the domain-name parsing request when receiving the domain-name parsing request.

In one embodiment, providing a corresponding NS record based on information of a top-level domain name in the domain-name parsing request includes: providing an external device corresponding to the corresponding NS record, a top-level domain name for parsing by the external device being different from the top-level domain name in the domain-name parsing request.

To implement the aforementioned goal and other related goals, the present disclosure provides a database system, including: at least one IP address and geographical location information of at least one network operator having a one-to-one correspondence relationship with the at least one IP address, wherein the geographical location information of at least one network operator is associated with A-records of corresponding DNS servers.

To implement the aforementioned goal and other related goals, the present disclosure provides a server, including the database system according to claim 6, wherein when the server receives a domain-name parsing request from an external device, the server matches a public IP of the external device with at least one IP address to locate geographical location information of a corresponding network operator, and sends an A-record of an authoritative DNS server associated with the network operator to the external device.

To implement the aforementioned goal and other related goals, the present disclosure provides a domain-name parsing method, being applied to the DNS network system according to claim 1, including: receiving, by a local DNS server of at least one network operator, a domain-name parsing request from a client terminal of the at least one network operator, and sending, by the local DNS server of at least one network operator, layer by layer, the domain-name parsing request from a root server to a lower-level authoritative DNS server for recursive query; sending, by the local DNS server, the domain-name parsing request to the root server, and receiving, by the local DNS server, an NS record of an upper-level authoritative DNS server returned by the root server; sending, by the local DNS server, the domain-name parsing request to the upper-level authoritative DNS server, and receiving, by the local DNS server, an NS record of an external authorized server returned by the upper-level authoritative DNS server; sending, by the local DNS server, the domain-name parsing request to the external authorized server, and receiving, by the local DNS server, an A-record of a lower-level authoritative DNS server returned by the external authorized server, wherein an IP address corresponding to geographical location information of a network operator associated with A-record matches a public IP of the local DNS server; and sending, by the local DNS server, the domain-name parsing request to the lower-level authoritative DNS server, and receiving, by the local DNS server, a domain-name parsing result returned by the lower-level authoritative DNS server.

In one embodiment, the domain-name parsing method further includes: returning, by the upper-level authoritative DNS server, the external authorized server to the local DNS server, wherein a top-level domain name being parsed by the external authorized server is different from a top-level domain name in the domain-name parsing request.

To implement the aforementioned goal and other related goals, the present disclosure provides a domain-name parsing system, including: a first transceiver module, for an DNS server of at least one network operator to correspondingly receive a domain-name parsing request from a client terminal of the at least one network operator; a second transceiver module, for the local DNS server to send the domain-name parsing request from a root server to a lower-level authoritative DNS server for recursive query and receive an NS record of an upper-level authoritative DNS server returned by the root server; a third transceiver module, for the local DNS server to send the domain-name parsing request to the upper-level authoritative DNS server, and receive an NS record of an external authorized server returned by the upper-level authoritative DNS server; a fourth transceiver module, for the local DNS serve to send the domain-name parsing request to the external authorized server, and receive an A-record of a lower-level authoritative DNS server returned by the external authorized server, wherein an IP address corresponding to geographical location information of a network operator associated with A-record matches a public IP of the local DNS server; and a fifth transceiver module, for the local DNS server to send the domain-name parsing request to the lower-level authoritative DNS server, and receive a domain-name parsing result returned by the lower-level authoritative DNS server.

As illustrated above, the DNS network system, domain-name parsing method and system, database system, and server provided by the present disclosure may allow a request by a server in a local operator to be received in the local operator and a request by a server in a local region to be received by a server in the local region, such that failure rates of cross-operator and cross-region parsing may be reduced. The ultimate authoritative DNS server may be located rapidly, and DNS parsing may be improved. In addition, if the ultimate authoritative DNS server is under attack, the impact caused by the attack may be limited to only the region under attack and would not affect the entire network. Further, in the present disclosure, the division of the ultimate authoritative DNS servers may be implemented through the A-record. By modifying the A-record, fast scheduling may be obtained.

### BRIEF DESCRIPTION OF THE DRAWINGS

FIG. 1 illustrates a structure of an exemplary DNS network system consistent with the disclosed embodiments of the present disclosure;

FIG. 2 illustrates an exemplary flow chart of a domain-name parsing process consistent with the disclosed embodiments of the present disclosure; and

FIG. 3 illustrates an exemplary block diagram of a domain-name parsing process consistent with the disclosed embodiments of the present disclosure.

### DETAILED DESCRIPTION

Other advantages and effects of the present disclosure will become apparent to those skilled in the art from the following description of the present disclosure by way of specific embodiments with reference to the accompanying drawings. The present disclosure may also be embodied or applied by a further different embodiment, and the details in this specification may be modified or varied without departing from the spirit of the disclosure on the basis of different views and applications. It is to be noted that, without conflict, the features of the following embodiments and examples may be combined with each other.

It should be noted that the illustrations provided in the following examples illustrate only the basic concept of the present disclosure in a schematic manner, and only the components related to the present disclosure are shown in the drawings, rather than the number, shape and size of the actual components. The actual implementation of the various components of the type, quantity and proportion can be changed flexibly, and the layout type of components may also be more complex.

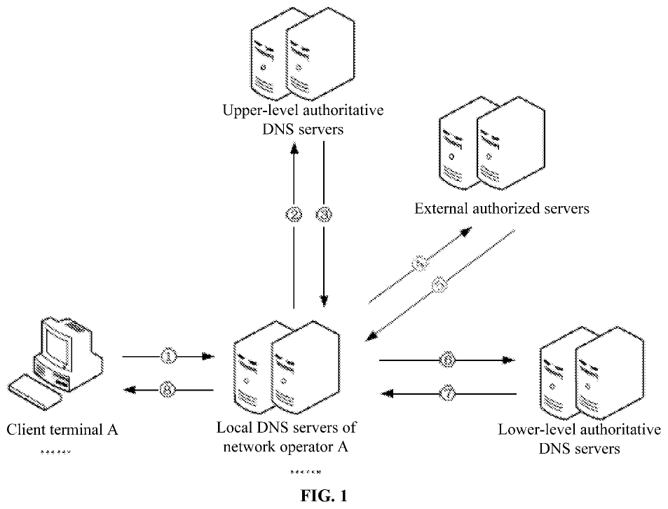

As show in FIG. 1, the present disclosure provides a DNS network system, including:

(1) The local DNS server of at least one network operator, e.g., a public-network DNS server of China Telecom or public-network DNS servers of China Unicom. The local DNS server is used for \textcircled{1} receiving a domain-name parsing request from a client terminal of the at least one network operator, and sending the domain-name parsing request, lever by level, from the root server to a lower-level authoritative DNS server for recursive query. For example, client terminal A is a client of network operator A, and the domain-name parsing request for aaa.com sent by the client terminal A may be received by a public-network DNS server of the network operator A. In another example (not shown), client terminal B is a client of network operator B, and the domain-name parsing request for aaa.com may be received by a public-network DNS server of the network operator B.

(2) An upper-level authoritative DNS server for storing the NS record of at least one external authorized server. The upper-level authoritative DNS server is configured for, when \textcircled{2} receiving the domain-name parsing request from the local DNS server, providing corresponding NS record to the local DNS server \textcircled{3} based on the information of the top-level domain name in the domain-name parsing request, thus enabling the local DNS server to access a corresponding external authorized server according to the A-record in the NS record. That is, in the present disclosure, the upper-level authoritative DNS servers originally used to parse top-level domain names may not directly parse domain names. Instead, the upper-level authoritative DNS server may authorize the external authorized server to parse the top-level domain names. It should be noted that, the top-level domain name parsed by the external authorized server is different from the top-level domain name in the domain-name parsing request, so as to prevent the local DNS server from accessing the upper-level authoritative DNS server again. For example, the upper-level authoritative DNS server may be a COM server used for parsing top-level domain names with “.com”. Then, the external authorized server may not be a COM server and may be a CN server for parsing top-level domain names with “.cn”. The external authorized server may also be a NET server for parsing top-level domain names with “.net”, and so on. If the external authorized server is a COM server, the domain-name parsing request may be returned to the upper-level authoritative DNS server, and may not be forwarded to the external authorized server for the subsequent operations.

(3) The external authorized server. The external authorized server stores at least one IP address and the geographical location information of at least one operator forming a one-to-one correspondence relationship with the at least one IP address. The geographical location information of the at least one operator may each be associated with the corresponding A-records of lower-level authoritative DNS servers. For example, the external authorized server stores Table 1 and Table 2. Table 1 includes an IP address range starting from “beginning of IP” to “end of IP”. Each IP address range may correspond to the corresponding geographical location information of the operators. As shown in Table 1, an IP address in the IP address range of “1.1.1.1.-1.1.1.255” may correspond to an operator having the geographical location information of “dx_Fujian”, indicating “The Telecommunications of Fujian Province”. After “dx_Fujian” has been located, the “202.101.98.55” can be found as the A-record of the lower-level authoritative DNS server in Table 2. It should be noted that, when adding or removing an external authorized server, the NS record in Table 2 may be added or deleted accordingly, as well as the geographic location information of the operators and the A-records of the lower-level authoritative DNS servers.

TABLE 1

| | |
|---|---|
| IP address range | Geographical location |

| Beginning of IP | End of IP | information of operators |
|---|---|---|
| 1.1.1.1 | 1.1.1.255 | dx_Fujian |
| . . . | . . . | . . . |

TABLE 2

| | Geographical location | A-record of lower-level |
|---|---|---|
| NS | information of operators | authoritative DNS server |
| dns1.aaa.co | dx_Fujian | 202.101.98.55 |
| . . . | . . . | . . . |

When \textcircled{4} receiving the domain-name parsing request sent by the local DNS servers, the external authorized server may \textcircled{5} match the IP of the request, i.e., the public IP of the local DNS servers, to at least one IP address, to search for the corresponding geographical location information of operator, and provide the A-record of the lower-level authoritative DNS servers, associated with the geographical location information of the operator, to the local DNS servers for access. Thus, when a lower-level authoritative DNS server is added or deleted, only the A-record stored in the external authorized server need to be modified accordingly.

(4) The lower-level authoritative DNS server. The lower-level authoritative DNS server is used for \textcircled{7} parsing the domain-name parsing request and providing a domain-name parsing result to the local DNS server \textcircled{6} when receiving the domain-name parsing request sent by the local DNS server.

It should be noted that, in the present disclosure, the upper-level authoritative DNS server may be authorized by the root server based on the top-level domain name in the domain-name parsing request. Apparently, besides authorizing the external authorized server by the upper-level authoritative DNS server, a next level authoritative DNS server of the upper-level authoritative DNS server, i.e., the authoritative DNS server for parsing the next level domain name, may also authorize the external authorized server, and so on. The next level authoritative DNS servers lower than the upper-level authoritative DNS server authorizing the external authorized server may have an inferior technical effect.

Similar to the working principles illustrated in the aforementioned embodiments, the present disclosure provides a server, which stores the NS record of at least one external device. When receiving a domain-name parsing request, the server may provide corresponding NS record based on the information of top-level domain name in the domain-name parsing request. Because the technical features illustrated in the aforementioned embodiments may also be in accordance with the present embodiment, repeated descriptions are not provided herein. It should be noted that, providing corresponding NS record based on the information of top-level domain name in the domain-name parsing request may include providing the external device corresponding to the NS record. The top-level domain name parsed by the external device may be different from the domain name in the domain-name parsing request.

Similar to the aforementioned working principles of the embodiments, the parent disclosure provides a database system. The database system may include at least one IP address and the geographical location information of at least one network operator forming a one-to-one correspondence relationship with the at least one IP address. The geographical location information of the at least one network operator may each be associated with the corresponding A-record of authoritative DNS servers, e.g., as shown in Tables 1 and 2. The technical features of the aforementioned embodiments may be applied in the present disclosure, and the technical features of the database system is not repeated herein.

Similar to the working principles of the aforementioned embodiments, the parent disclosure provides a server, including the aforementioned database system. The server may, when receiving the domain-name parsing request sent by an external device, match the IP of the external device to the at least one IP address, to search for the corresponding geographical location information of the network operator, and to provide the A-record of the authoritative DNS servers, associated with the geographical location information of the network operator, to the external device. The technical features of the aforementioned embodiments may be applied in the present embodiment, and the technical features of the server is not repeated herein.

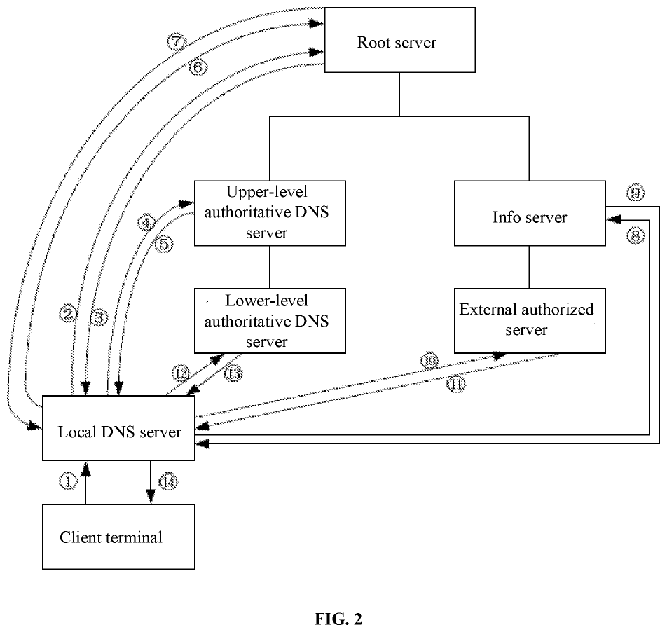

As shown in FIG. 2, similar to the working principle of the aforementioned embodiments, the present disclosure provides a domain-name parsing method. The domain-name parsing method may be applied in any of the mentioned DNS network systems. The technical features of the previous embodiments may be applied in the present disclosure, and the technical features of the domain-name parsing method is not repeated herein. Embodiments of the domain-name parsing method is illustrated in detail.

\textcircled{1} The local DNS server of at least one network operator may correspondingly receive a domain-name parsing request from a client terminal of at least one network operator, e.g., inquiring the A-record of wsdns.com.

\textcircled{2} The local DNS server may send the domain-name parsing request to the root server.

\textcircled{3} The root server may return the NS record of an upper-level authoritative DNS server (e.g., COM server) to the local DNS server.

\textcircled{4} The local DNS server may send the domain-name parsing request to the upper-level authoritative DNS server.

\textcircled{5} The upper-level authoritative DNS server may notify the local DNS server that the info server has been authorized. It should be noted that, similar to the process that bbb.com obtains authorization from com when registering the domain name, the external authorized server in the present disclosure, when established, may register and obtain authorization from the info server. Further, the NS record of info sever may point to the external authorized server.

\textcircled{6} The local DNS server may inquire the root server for the NS record of the info server.

\textcircled{7} The root server may send the NS record of the info server to the local DNS server.

\textcircled{8} The local DNS server may send the domain-name parsing request to the info server.

\textcircled{9} The info server may send the NS record of the external authorized server to the local DNS server, the top-level domain name parsed by the external authorized server may be different from the top-level domain name in the domain-name parsing request.

\textcircled{10} The local DNS server may send the domain-name parsing request to the external authorized server.

\textcircled{11} The external authorized server may allocate the A-record of a lower-level authoritative DNS server to the local DNS server. The IP address, corresponding to the geographical location information of a network operator associated with the A-record, may match the public IP of the local DNS server.

\textcircled{12} The local DNS server may send the domain-name parsing request to the lower-level authoritative DNS server.

\textcircled{13} The lower-level authoritative DNS server may send the domain-name parsing result to the local DNS server.

\textcircled{14} The local DNS server may return the domain-name parsing result to the client terminal for access.

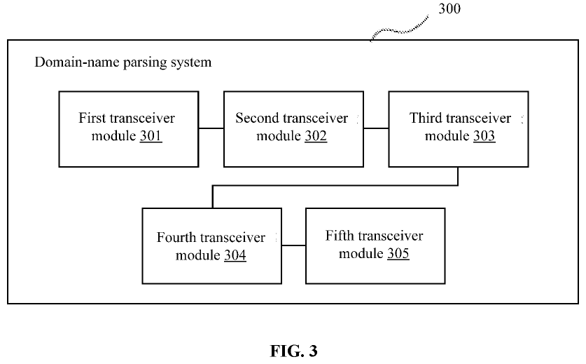

As shown in FIG. 3, similar to the working principles of the aforementioned domain-name parsing method, the present disclosure provides a domain-name parsing system 300, being a software configured on a hardware device, e.g., a local DNS server. The domain-name parsing system 300 may include a first transceiver module 301, a second transceiver module 302, a third transceiver module 303, a fourth transceiver module 304, and a fifth transceiver module 305. The technical features of the aforementioned embodiments may be applied in the present disclosure, and the technical features of the domain-name parsing system is not repeated herein.

The first transceiver module 301 may receive a domain-name parsing request from the client terminal of a network operator in the same network; the second transceiver module 302 may send the domain-name parsing request to the root server and receive the NS record of the upper-level authoritative DNS server returned by the root server; the third transceiver module 303 may send the domain-name parsing request to the upper-level authoritative DNS server and receive the NS record of an external authorized server returned by the upper-level authoritative DNS server; the fourth transceiver module 304 may send the domain-name parsing request to the external authorized server and receive the A-record of a lower-level authoritative DNS server returned by the external authorized server, where the IP address corresponding to the geographical location information of a network operator associated with the A-record, may match the public IP of the local DNS server; and the fifth transceiver module 305 may send the domain-name parsing request to the lower-level authoritative DNS and receive the domain-name parsing result returned by the lower-level authoritative DNS.

Thus, by external authorization, the DNS network system, domain-name parsing method and system, provided by the present disclosure, may assign the domain-name parsing request sent by the client terminal of each network operator to a desired authoritative server to parse. Parsing of domain names may be more efficient. The present disclosure effectively overcomes various shortcomings in the conventional technology and thus has high industrial value.

The abovementioned embodiments merely illustrate the principles and effects of the present disclosure and are not intended to limit the disclosure. Any person skilled in the art will be able to modify or alter the abovementioned embodiments without departing from the spirit and scope of the disclosure. Accordingly, all equivalents or modifications that may be made by those skilled in the art without departing from the spirit and technical concept disclosed in the present disclosure are intended to be embraced by the claims of the present disclosure.

1. A domain name system (DNS) network system, comprising:
a local DNS server of at least one network operator, configured to receive a domain-name parsing request from a client terminal of the at least one network operator, and sending the domain-name parsing request from a root server to a lower-level authoritative DNS server level by level for performing a recursive query;
a lower-level authoritative DNS server, configured to parse the domain-name parsing request to provide a domain-name parsing result to the local DNS server when receiving the domain-name parsing request sent by the local DNS server;
an external authorized server storing at least one IP address and geographical location information of the at least one network operator having a one-to-one correspondence relationship with the at least one IP address; and
an upper-level authoritative DNS server storing NS records of at least one type of external authorized servers, configured to, when receiving the domain-name parsing request from the local DNS server, provide a corresponding NS record to the local DNS server based on information of a top-level domain name in the domain-name parsing request, such that the local DNS server accesses an external authorized server;
wherein the geographical location information of the at least one network operator each associates with an A-record of a corresponding lower-level authoritative DNS server, and the external authorized server is configured to, when receiving the domain-name parsing request from the local DNS server, match a public IP of the local DNS server with the at least one IP address to locate the geographical location information of the network operator, and provide the A-record of the corresponding lower-level authoritative DNS server associated with the network operator to the local DNS server for the local DNS server to access.

2. The DNS network system according to claim 1, wherein:
the upper-level authoritative DNS server is further configured to provide the external authorized server to the local DNS server, and a top-level domain name parsed by the external authorized server is different from the top-level domain name in the domain-name parsing request.

3. The DNS network system according to claim 1, wherein when adding or deleting an external authorized server and/or a lower-level authoritative DNS server, the NS record and/or corresponding A-record are modified accordingly.

4. A server, wherein:
the server stores a NS record of at least one external device, and
the server is configured to:
when receiving a domain-name parsing request, provide a corresponding NS record based on information of a top-level domain name in the domain-name parsing request.

5. The server according to claim 4, wherein:
the server is further configured to provide an external device corresponding to the corresponding NS record, and
a top-level domain name for parsing by the external device is different from the top-level domain name in the domain-name parsing request.

6. (canceled)

7. The server according to claim 4, wherein when the server receives a domain-name parsing request from an external device, the server matches a public IP of the external device with at least one IP address to locate geographical location information of a corresponding network operator, and sends an A-record of an authoritative DNS server associated with the network operator to the external device.

8. A domain-name parsing method, being applied to a DNS network system, comprising:
receiving, by a local DNS server of at least one network operator, a domain-name parsing request from a client terminal of the at least one network operator, and sending, by the local DNS server of at least one network operator, level by level, the domain-name parsing request from a root server to a lower-level authoritative DNS server for performing a recursive query;
sending, by the local DNS server, the domain-name parsing request to the root server, and receiving, by the local DNS server, an NS record of an upper-level authoritative DNS server returned by the root server;
sending, by the local DNS server, the domain-name parsing request to the upper-level authoritative DNS server, and receiving, by the local DNS server, an NS record of an external authorized server returned by the upper-level authoritative DNS server based on information of a top-level domain name in the domain-name parsing request;
sending, by the local DNS server, the domain-name parsing request to the external authorized server, and receiving, by the local DNS server, an A-record of a lower-level authoritative DNS server returned by the external authorized server, wherein an IP address corresponding to geographical location information of a network operator associated with A-record matches a public IP of the local DNS server; and
sending, by the local DNS server, the domain-name parsing request to the lower-level authoritative DNS server, and receiving, by the local DNS server, a domain-name parsing result returned by the lower-level authoritative DNS server.

9. The domain-name parsing method according to claim 8, wherein:
a top-level domain name parsed by the external authorized server is different from the top-level domain name in the domain-name parsing request.

10. A domain-name parsing system, comprising:
a first transceiver module, configured to enable an DNS server of at least one network operator to correspondingly receive a domain-name parsing request from a client terminal of the at least one network operator;
a second transceiver module, configured to enable the local DNS server to send the domain-name parsing request from a root server to a lower-level authoritative DNS server for recursive query and receive an NS record of an upper-level authoritative DNS server returned by the root server;
a third transceiver module, configured to enable the local DNS server to send the domain-name parsing request to the upper-level authoritative DNS server, and receive an NS record of an external authorized server returned by the upper-level authoritative DNS server;
a fourth transceiver module, configured to enable the local DNS server to send the domain-name parsing request to the external authorized server, and receive an A-record of a lower-level authoritative DNS server returned by the external authorized server, wherein an IP address corresponding to geographical location information of a network operator associated with A-record matches a public IP of the local DNS server; and
a fifth transceiver module, configured to enable the local DNS server to send the domain-name parsing request to the lower-level authoritative DNS server, and receive a domain-name parsing result returned by the lower-level authoritative DNS server.

11. The domain-name parsing system according to claim 10, wherein:
the upper-level authoritative DNS serve returns the NS record of the external authorized server to the local DNS server based on information of a top-level domain name in the domain-name parsing request.

12. The domain-name parsing system according to claim 11, wherein:
a top-level domain name parsed by the external authorized server is different from the top-level domain name in the domain-name parsing request.

13. The domain-name parsing system according to claim 10, wherein when adding or deleting an external authorized server and/or a lower-level authoritative DNS server, the NS record and/or corresponding A-record are modified accordingly.

14. The domain-name parsing method according to claim 8, wherein:
the external authorized server stores at least one IP address and geographical location information of at least one network operator forming a one-to-one correspondence relationship with the at least one IP address.

15. The domain-name parsing method according to claim 8, wherein the sending, by the local DNS server, the domain-name parsing request to the external authorized server comprises:
matching the public IP of the local DNS servers, to at least one IP address, to search for the corresponding geographical location information of operator, and providing the A-record of the lower-level authoritative DNS servers, associated with the geographical location information of the operator, to the local DNS servers for access.

16. The domain-name parsing method according to claim 9, wherein:
the upper-level authoritative DNS server is authorized by the root server based on the top-level domain name in the domain-name parsing request.
